(19) United States
(12) Patent Application Publication
(10) Pub. No.: US 2025/0094881 A1
(43) Pub. Date: Mar. 20, 2025

(54) MACHINE LEARNING FRAMEWORK FOR GENERATING MULTIPLE MACHINE-LEARNED MODELS BASED ON DIFFERENT SETS OF TRAINING DATA

(71) Applicant: PREDICT HQ LIMITED, San Francisco, CA (US)

(72) Inventors: Xuxu Wang, Auckland (NZ); Xiping Fu, Auckland (NZ)

(21) Appl. No.: 18/368,525

(22) Filed: Sep. 14, 2023

Related U.S. Application Data
(63) Continuation of application No. 18/075,340, filed on Dec. 5, 2022, now abandoned.

(51) Int. Cl. G06N 20/20

(52) U.S. Cl. CPC G06N 20/20

(57) ABSTRACT

A framework for generating multiple machine-learned (ML) models in order to learn the impact of real-world events is provided. In one technique, sets of feature values (FVs) are stored, each FV set corresponding to a different feature. Also, sets of artificial FVs (AFVs) are generated. For each generated AFV set: (1) a training dataset is generated based on that AFV set and the multiple FV sets; (2) a model is generated based on the training dataset; (3) a ranking of the multiple features is generated based on the model; and (4) the ranking is stored in a dictionary corresponding to the generated AFV set. For each feature, a rank pair of the feature and an AF is determined from each dictionary. Based on a set of rank pairs associated with the feature, it is determined whether there is significant correlation between the feature and a response variable of the models.

### TECHNICAL FIELD

The present disclosure generally relates to machine learning and, more particularly, to a framework for generating multiple machine-learned models.

### BACKGROUND

Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users. The statistical model is trained based on multiple attributes. In machine learning parlance, such attributes are referred to as “features.” To generate and train a statistical prediction model, a set of features is specified and a set of training data is identified.

Example machine learning techniques include linear regression, logistic regression, random forests, naive Bayes, and Support Vector Machines (SVMs). Advantages that machine-learned classifiers or prediction models have over rule-based classifiers include the ability of machine-learned classifiers to output a probability (as opposed to a number that might not be translatable to a probability), the ability of machine-learned classifiers to capture non-linear correlations between features, and the reduction in bias in determining weights for different features.

### BRIEF DESCRIPTION OF THE DRAWINGS

In the drawings:

FIG. 1 is a block diagram that depicts an example system for implementing a feature importance framework, in an embodiment;

FIG. 2 is a diagram depicting event category importance simulation results, in an embodiment;

FIG. 3 is a flow diagram that depicts an example process for using statistical techniques to identify event categories that have an effect on user behavior, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Impacts of Real-World Events

Owners of organizations that have online presence and/or physical presence desire to know what events, if any, impact user traffic. The types or categories of events may vary widely, such as sports, conferences, public holidays, and school holidays. Some events may have a large impact on user traffic while other events may have little to no impact.

Understanding which events have the most impact will help such owners in decision making and adjusting processes in anticipation of future events.

### Machine-Learned Model Feature Importance

In the machine learning field, feature importance methods are relevant for answering the question of which events have the most impact on user traffic. Such methods usually output a set of feature importance scores that could be used for deciding which features are most relevant to a response (or dependent) variable. A cutting edge feature importance method is the permutation feature importance (PFI) testing model with a Gradient boosting machine (GBM).

However, there are some drawbacks of only using PFI. For example, the outputted feature importance scores are relative, not absolute. While PFI importance scores show the relative predictive power of features in a model, these importance scores do not have any meaningful value out of context. Any score could be considered really important or unimportant depending on the other scores.

Another drawback of only using PFI is that such feature importance is not statistical inference. For example, the feature importance scores indicate the relative importance of each feature, but they do not indicate the features which have significant impact to user traffic. Another drawback is the inconsistency and instability of feature importance testing results. The PFI relies on the performance of GBM, which aims to learn the relationship between the features and the user traffic. In practice, the features might not contain all the information for predicting the user traffic, and the relationship between features and user traffic might have a complex, non-linear relationship, which means that the model might not learn the relationship very well. All of these factors might impact the results of PFI.

### General Overview

A system and method for providing a machine-learned model generation framework are provided. The framework addresses current challenges of determining importance of multiple features of a machine-learned model. This framework is based on Null Hypothesis Significance Testing (NHST) and explores the results of a feature importance method (such as PFI) by injecting artificial noisy features in a ML model generation stage. With statistical testing, a statistical correlation between a response variable and events is tested for each feature, which may correspond to an event category. With this approach, the consistency and stability of feature importance testing algorithms are improved. Furthermore, given statistical correlation as proof points, it is possible to arrive to a fixed conclusion on event category importance.

### System Overview

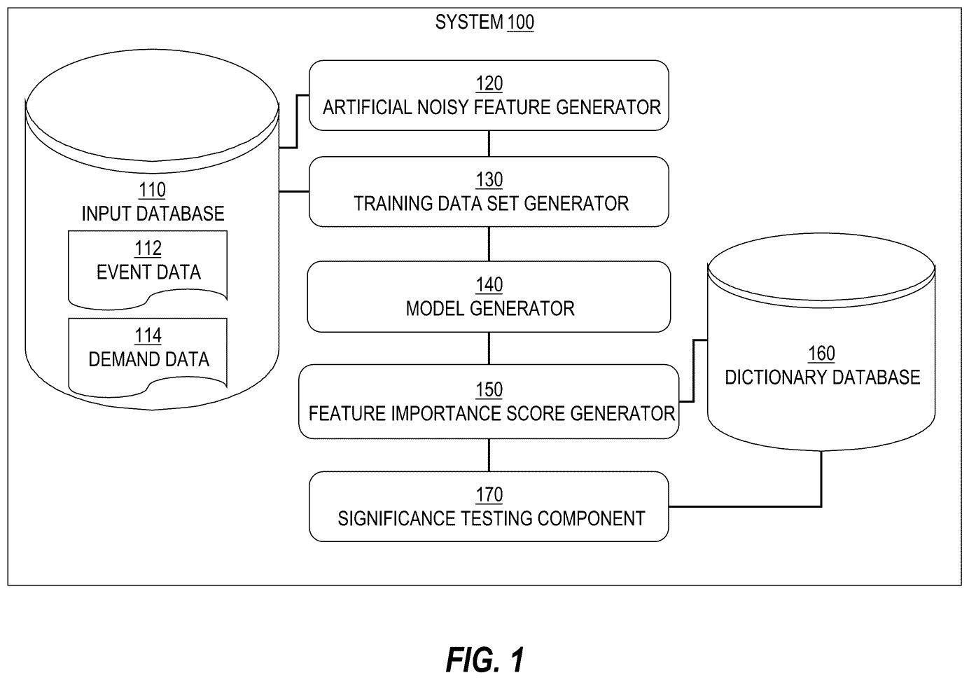

FIG. 1 is a block diagram that depicts an example system 100 for implementing a feature importance framework, in an embodiment. System 100 comprises input database 110, an artificial noisy feature generator 120, a training data set generator 130, a model generator 140, a feature importance score generator 150, a dictionary database 160, and a significance testing component 170. Each of artificial noisy feature generator 120, model generator 140, feature importance score generator 150, and significance testing component 170 may be implemented in hardware, software, or any combination of hardware and software. System 100 may include other elements not depicted in FIG. 1 that perform other functions to assist in providing a feature importance framework.

Although artificial noisy feature generator 120, model generator 140, feature importance score generator 150, and significance testing component 170 are depicted as separate elements, all or a subset of the functions performed may be integrated into a single component or element, such as a single program. Also, although artificial noisy feature generator 120, model generator 140, feature importance score generator 150, and significance testing component 160 may be implemented on the same computing device or on separate computing devices that are communicatively coupled in a network, such as a local area network (LAN) or in a cloud environment.

The lines in FIG. 1 connecting different components or elements of system 100 illustrate one example in which the different elements may interact. For example, training data set generator 130 may send a training data set to model generator 140 directly, may notify model generator 140 that a training data set is available (and, optionally, provide physical or logical location data regarding where the training data set may be retrieved), or may not interact with model generator 140 at all. Instead, model generator 140 may be notified of an available training data set to process through an entirely different mechanism, such as an event publish-subscribe mechanism.

Input database 110 may be volatile or non-volatile storage, such as a disk or a solid state drive. Input database 110 stores two main types of data: event data 112 and demand data 114, such as remainder data and, optionally, baseline data.

Event data 112 includes multiple time series data sets, each pertaining to a particular type of event or event category. Examples of event categories include public holidays, school holidays, sporting events, conferences, concerts, expos, festivals, other performing arts events, etc. These are examples of external events, or events that are external to an entity that is seeking to influence user behavior, such as in-store traffic or online traffic to a particular website or online platform of, or associated with (e.g., owned by, managed by), the entity. Another example of an event category is internal promotions, or promotions that are offered by the entity that initiates, whether using internal resources (e.g., posters on a store front, coupons on a website of the entity) or relying on a third-party to conduct the promotion, such as advertisements online, on television, or in a newspaper.

A time series data set pertaining to an event category may have a number of values equal in number to the number of time units within a time period corresponding to the event category. For example, if a time period is one year and a time unit is a day, then the number of time units is 365 and the number of values in the time series data set is also 365. However, in many cases, the number of time units (e.g., days) with a corresponding zero value may be significant. For example, the number of public holidays in a year may be 14; thus, a time series data set for public holidays may have 351 zero values.

Alternatively, a time series data set may include only non-zero values. For example, if there are only five concerts in a year, then a time series data set for concerts may have five non-zero values and, for each non-zero value, a date on which the concert occurred. From such a time series data set, system 100 may automatically generate a feature data set that includes zeros for the days (or time units) on which an event of the corresponding event category did not occur, at least according to the time series data set.

A time series data set in event data 112 (or a feature data set from which the time series data set is generated) may comprise zeros and ones, for example, where zeros indicate that no such events of that event category took place during the corresponding time units and ones indicate that an event of that event category took place during the corresponding time units. For example, for a promotion, zeros may indicate that no promotions were running during the corresponding time units and ones may indicate that a promotion was available to customers during the corresponding time units. Alternatively, non-zero values may be values other than one. For example, for a sporting event category, a non-zero value may be an attendance at a stadium in which the sporting event took place.

A time series data set in event data 112 may originate from the same party that owns and/or operates system 100. Alternatively, the parties may be different. For example, a third-party that provides a good or service provides a demand data set to system 100 (e.g., from a computing device operated by the third-party over a computer network, such as the Internet) and the party that owns and/or operates system 100 generates the time series data set in event data 112. The party that owns and/or operates system 100 may generate some time series data sets in event data 112 while one or more other third-parties may provide, to system 100, other time series data sets in event data 112.

Demand data 114 comprises one or more time series data sets, where each time series data set reflects user behavior over time, such as an amount of sales per day for a year, a number of units sold per hour for a month, and a number of customers per day for a week. Thus, each value in a time series data set corresponds to a different time period (e.g., a different day of a particular year), but all values in the time series data set may correspond to the same length of time (e.g., 24 hours).

Demand data 114 may include both baseline data and remainder data, where the baseline data is generated based on an analysis of raw demand data. In this scenario, the remainder data is calculated by subtracting the baseline data from the raw demand data. A process for computing baseline data and remainder data from raw demand data is described in U.S. patent application Ser. No. 17/860,844, which is incorporated by reference above.

A time series data set in event data 112 may be applicable to a single demand data set or to multiple demand data sets. For example, a first third-party operates a first establishment in a first geographic location and a second third-party operates a second establishment in a second geographic location that is near the first geographic location. Thus, many events of a particular event category that occur at a third geographic location (e.g., a concert hall or a sports stadium) that is near the first and second geographic locations may affect user behavior at both the first and second establishments. In this example, a time series data set pertaining to the particular event category will be used to generate a set of feature values for demand-related data related to the first establishment and for demand-related data related to the second establishment.

The further away an event occurs relative to the store, the less likely that event will have an effect on user behavior in or around the store. A threshold distance may be defined such that if an event occurs a distance from a place of interest (e.g., a store) and that distance is greater than the threshold distance, then that event is not reflected in a time series data set as a source of a feature value of the corresponding event category.

### Artificial Noisy Feature Generator

Artificial noisy feature generator 120 generates one or more sets of noisy feature values based on one or more sets of feature values. For example, artificial noisy feature generator 120 generates ten sets of noisy feature values based on a set of feature values that corresponds to public holidays. A set of noisy feature values serves as a reference for testing whether an event category has statistical correlation to a response variable, such as remainder (demand) data in this example.

A set of noisy feature values may be generated in any number of ways. For example, artificial noisy feature generator 120 may take a set of feature values as input, make a copy of the set of feature values, randomly move each feature value in the copy to a different location in the copy (e.g., the feature value at location ten is moved to location ninety-three). As another example, each non-zero value in the copy is identified and moved to another location in the copy. In this way, zero values (indicating that no event occurred) do not have to be considered and may significantly speed up the generation of a set of noisy feature values. Such “shuffling” of feature values associated with an event category keeps certain properties of the event category feature. The shuffle only changes the order of feature values. Thus, the density and scale are the same as the original event category feature.

### Training Data Set Generator

Training data set generator 130 generates multiple training data sets, each for a different machine-learned (ML) model. A training data set is based on multiple time series data sets in event data 112 and a time series data set in demand data 114. One or more of the time series data sets are one or more sets of artificial noisy feature values. Each of the remaining time series data sets corresponds to a different event category of multiple event categories.

For each artificial noisy feature, that artificial noisy feature is added to a real event category feature set. For example, if there are nineteen event categories, then training data set generator 130 generates (1) a first training data set based on nineteen time series data sets and a first set of artificial noisy feature values and (2) a second training data set based on the nineteen time series data sets and a second set of artificial noisy feature values that is different than the first set of artificial noisy feature values. In fact, training data set generator 130 may generate one hundred and ninety training data sets, where each of the training data sets is based on the same nineteen time series data sets but a different set of noisy feature values.

Generating a training data set involves generating training instances, each training instance including a response value (or demand value) and multiple feature values. Thus, if there are nineteen event categories, then a training instance includes a value from a time series data set (from demand data 114) as the response value and a value from each of the nineteen time series data sets.

### Model Generator

Model generator 140 generates a model based on a training data set. Model generator 140 may implement one or more machine learning techniques to generate the model. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users and regions. The statistical model is trained based on multiple attributes (or factors) described herein. In machine learning parlance, such attributes are referred to as “features.” To generate and train a statistical model, a set of features is specified and a set of training data is identified.

Embodiments are not limited to any particular machine learning technique for generating or training a model. Example machine learning techniques include gradient boosting machines (GBMs), decision trees, logistic regression, and Support Vector Machines (SVMs). Model generator 140 may implement the same machine learning technique(s) to generate the same type of model for each of multiple training data sets that pertain to a particular demand data set.

In an embodiment, a training data set (generated by training data set generator 130) is split into a training set and a testing set. In other words, one portion of the training instances in the training data set are used for training a machine-learned model and another portion of the training instances in the training data set are used for testing the ML model. The testing set is used to ensure that the ML model is accurate along one or more dimensions, such as precision and recall. If the ML model passes one or more tests using the testing set, then the ML model is analyzed by feature importance score generator 150.

### Feature Importance Score Generator

Feature importance score generator 150 generates a feature importance score for each feature of a ML model generated (and, optionally, tested) by model generator 140. Feature importance score generator 150 may use one or multiple techniques to generate such a score. One example technique is permutation feature importance (PFI), which is a model-agnostic global explanation method that provides insights into a ML model's behavior. Generally, PFI estimates and ranks feature importance based on the impact each feature has on the trained ML model's predictions. Specifically, PFI measures the predictive value of a feature for any black box estimator, classifier, or regressor by evaluating how the prediction error increases when a feature is not available.

Based on a set of feature importance scores of a ML model, feature importance score generator 150 records the rank of each feature of the ML model (including the noisy feature). In other words, the feature importance scores are standardized into ranks. The feature with the largest feature importance score is ranked as 1, the feature with second largest feature importance score is ranked as 2, etc. The smaller rank integer means the higher rank. The following is an example of a rank results dictionary:

```
{
  “sports”:1,
  “concerts”:2,
  “public_holidays”:3,
  “artificial_noise_feature”:4,
  ...
}
```

In this example, the sports event category is ranked 1, the concerts event category is ranked 2, the public holidays event category is ranked 3, the artificial noisy feature is ranked 4, and one or more other event categories are ranked lower than 4.

If one hundred ML models are generated (because there are one hundred noisy features), then feature importance score generator 150 generates one hundred rank results dictionaries.

Feature importance score generator 150 stores each rank results dictionary in dictionary database 160, which may be volatile or non-volatile storage. Each rank results dictionary may be associated with a value that indicates a source of the time series data sets or a unique demand data set. In this way, a set of rank results dictionary that is based on the same underlying data (e.g., a particular demand data set from a particular source) may be analyzed together.

### Significance Testing Component

Significance testing component 170 determines a significance of each event category based on a set of rank results dictionaries from dictionary database 160. For example, significance testing component 170 selects an event category and extracts, from dictionary database 160, a set of rank pairs, each rank pair comprising (1) a rank of the selected event category in a rank results dictionary and (2) a rank of the artificial noisy feature from the same rank results dictionary. If there are one hundred rank results dictionaries pertaining to a particular demand data set, then there are one hundred rank pairs, each rank pair corresponding to a different rank results dictionary.

Significance testing component 170 repeats this process for each event category that is being tested. Thus, if there are nineteen event categories and one hundred rank results, then significance testing component 170 generates nineteen sets of one hundred rank pairs.

The null hypothesis H₀ that is being tested is that there is no correlation between event categories and demand residuals or remainder data. Once a set of rank pairs for an event category is extracted, significance testing component 170 conducts a one-tailed t-test to determine whether that event category is significantly higher than the rank of the artificial noisy feature. (Significance testing component 170 may test a significance of an event category before or after extracting a set of rank pairs for another event category.) A one-tailed t-test involves computing the statistical significance of a parameter inferred from a data set, in terms of a test statistic. The t-test may be used as a default testing method. Other testing methods might be considered, such as a sign test and a Wilcoxon signed-rank test.

One-tailed tests are used for asymmetric distributions that have a single tail, such as the chi-squared distribution, which are common in measuring goodness-of-fit. The null hypothesis H₀ will be rejected if the p-value of the test statistic is sufficiently extreme (vis-a-vis the test statistic's sampling distribution) and thus judged unlikely to be the result of chance. This is usually done by comparing the resulting p-value with the specified significance level, denoted by α when computing the statistical significance of a parameter. In a one-tailed test, “extreme” is decided beforehand as either meaning “sufficiently small” or meaning “sufficiently large”—values in the other direction are considered not significant. One may report that the left or right tail probability as the one-tailed p-value, which ultimately corresponds to the direction in which the test statistic deviates from H₀.

Significance testing component 170 records the p-value of the test for each event category that is tested. If an event category has a p-value that is less than, for example, 0.1, then that event category is considered significant or important. In other words, there is sufficient confidence that that event category has a significant impact on demand data and its impact is revealed in the corresponding remainder data, as determined based on the training of ML models (which are based on noisy features) and the significance testing.

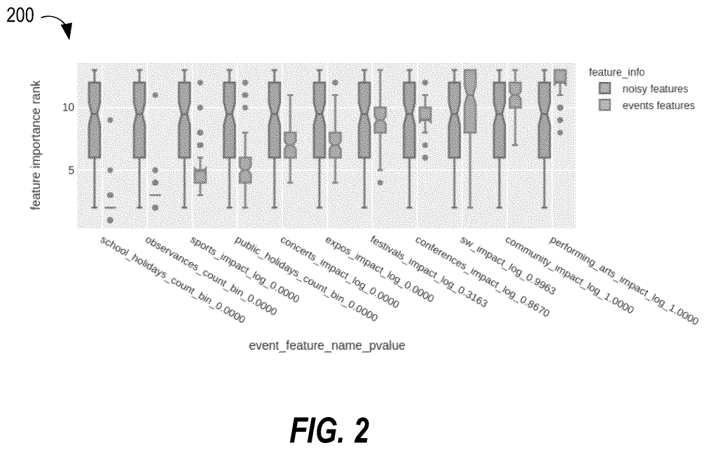

FIG. 2 is a diagram depicting event category importance simulation results 200, in an embodiment. For each event category, two box plots are displayed to show the distribution of the feature importance ranks of noisy features and event category features, respectively. Thus, because eleven event category features are listed, eleven identical box plots for the noisy feature are depicted.

The box portion of each box plot includes three lines: one for 25th percentile, one for 50% percentile (the middle line in the box), and one for 75% percentile. The “whiskers” or lines (connected by the vertical lines connected to the box) above and below the box may represent the maximum and minimum values or other values that are, respectively, (1) between the maximum and 75% percentile and (2) between the minimum and 25% percentile. In this example, data points for some event categories are found outside the corresponding whiskers.

The p-value of the significance testing is displayed next to the feature name of each event category. For example, the p-value for concerts is 0.0 while the p-value for festivals is 0.3163. Also, from the plot, it can be concluded that six event categories are significant in the sense of their respective impact to demand.

### Process Overview

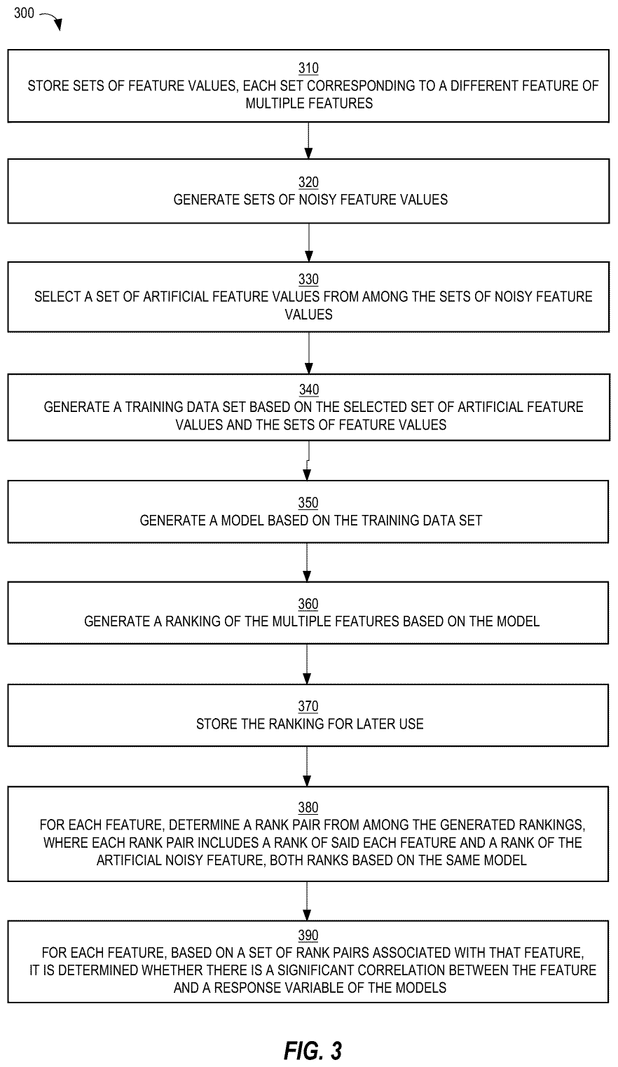

FIG. 3 is a flow diagram that depicts an example process 200 for using statistical techniques to identify event categories that have an effect on user behavior, in an embodiment.

At block 310, sets of feature values are stored, each set of feature values corresponding to a different feature of multiple features. Each set of feature values may be time series data that comprises multiple values, each corresponding to a different time period (e.g., a particular day) of multiple time periods.

At block 320, sets of noisy feature values are generated. Each set of noisy feature values comprises multiple values. The number of values in each set may be equal in number to the number of values in a set of feature values. Block 320 may involve generating one or more sets of noisy feature values based on a different set of feature values of the sets of feature values.

At block 330, a set of artificial feature values from among the sets of noisy feature values is selected. The order in which a set of artificial feature values is selected is not important. Thus, this selection may be random or may be based on which set of noisy feature values was generated first.

At block 340, a training data set is generated based on the selected set of artificial feature values and the sets of feature values. Block 340 may involve including, for each training instance, a value from a remainder data set and values (from the sets of feature values and set of artificial feature values) that pertain to the same time period as the value from the remainder data set. Once generated, the training data set may be divided into a training set and a testing set.

At block 350, a model is generated based on the training data set (or based only on the training set if there is also a testing set). Block 350 may involve using one or more machine-learning techniques (such as GBM) to train the model based on the training data set (or a portion thereof). Thus, the model is a machine-learned model.

At block 360, based on the model, a ranking of the multiples features is generated. Block 360 may involve generate a feature importance score for each feature based on the model and, optionally, a testing set that is input to the model.

At block 370, the ranking is stored for later use. Block 370 may involve storing the ranking in a database along with data that (a) identifies the artificial feature values that were used to generate the training data set and/or (b) a demand data set that is associated with the sets of feature values. Process 300 returns to block 330 if there are any unselected sets of artificial feature values. Otherwise, process 300 proceeds to block 380.

At block 380, for each feature, a rank pair is determined from among the generated rankings, where each rank pair corresponds to a different ranking and comprises a rank of the feature in that ranking and a rank of the artificial noisy feature in that ranking. Because multiple models were generated, block 380 may involve identifying multiple rank pairs for each feature, each rank pair for a particular feature including a rank of that particular feature and a rank of the artificial noisy feature, both ranks based on the same generated model.

At block 390, for each feature, based on a set of rank pairs associated with that feature, it is determined whether there is a significant correlation between the feature and a response variable of the models. Block 390 may involve a performing a statistical test, such as a one-tail test, to calculate a p-value for a feature and comparing the p-value to a particular threshold.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

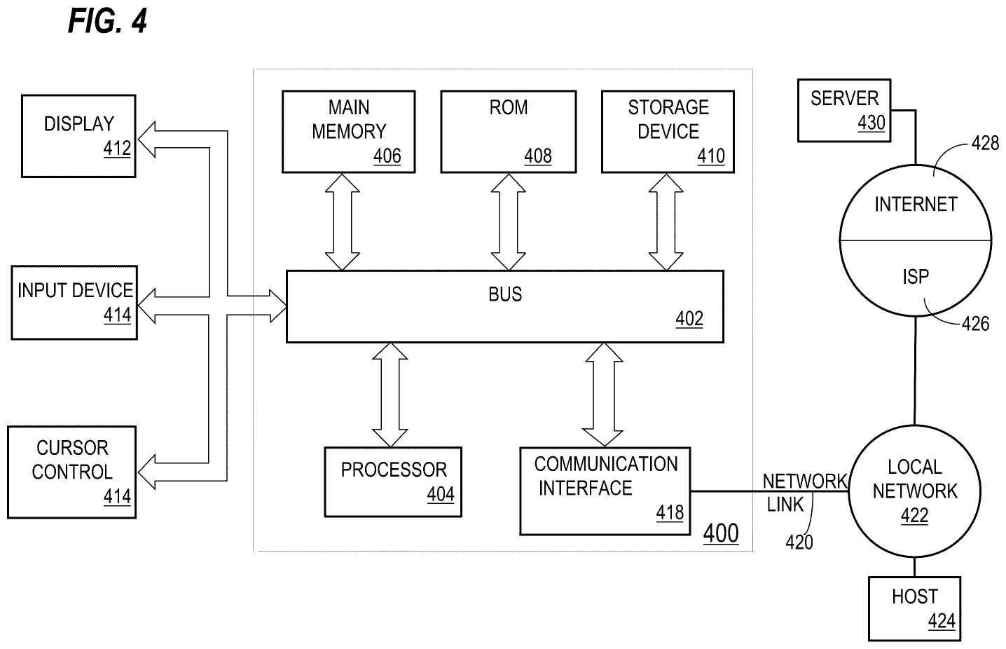

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
generating a plurality of sets of artificial feature values, wherein generating the plurality of sets of artificial feature values comprises:
identifying a set of feature values in a plurality of sets of feature values;
shuffling the set of feature values to generate a set of artificial feature values, wherein the set of artificial feature values is included in the plurality of sets of artificial feature values;
for each set of artificial feature values of the plurality of sets of artificial feature values:
generating a training data set based on said each set of artificial feature values and the plurality of sets of feature values;
wherein each set of feature values in the plurality of sets of feature values corresponds to a different feature of a plurality of features;
generating a machine-learned model based on the training dataset;
based on the machine-learned model, generating a ranking of the plurality of features;
adding the machine-learned model to a set of machine-learned models;
storing the ranking in a dictionary, of a plurality of dictionaries, that corresponds to said each set of artificial feature values;
for each feature of the plurality of features:
for each dictionary of the plurality of dictionaries:
generating a rank pair comprising (1) a rank of said each feature, in said each dictionary, relative to other features of the plurality of features and (2) a rank of an artificial feature, in said each dictionary, relative to other features of the plurality of features;
adding the rank pair to a set of rank pairs associated with said each feature;
wherein after generating the rank pair for each dictionary of the plurality of dictionaries, the set of rank pairs is a plurality of rank pairs associated with said each feature;
based on the plurality of rank pairs associated with said each feature, determining whether there is significant correlation between said each feature and a response variable of the set of machine-learned models;
wherein the method is performed by one or more computing devices.

2. The method of claim 1, wherein determining whether there is significant correlation comprises:
conducting a statistical test based on the set of rank pairs that results in a p-value for said each feature;
determining whether the p-value is less than a particular threshold.

3. The method of claim 1, wherein generating the plurality of sets of artificial feature values comprises generating a particular set of artificial feature values, in the plurality of sets of artificial feature values, based on a particular set of feature values in the plurality of sets of feature values.

4. The method of claim 3, wherein generating the particular set of artificial feature values comprises randomly shuffling feature values in the particular set of feature values to generate the particular set of artificial feature values.

5. The method of claim 1, wherein generating the plurality of sets of artificial feature values comprises, for each set of feature values in the plurality of sets of feature values, generating multiple sets of artificial feature values.

6. The method of claim 1, wherein generating the machine-learned model comprises using a gradient boosting machine to generate a regression model.

7. The method of claim 1, further comprising:
based on the machine-learned model, generating a feature importance score for each feature in the plurality of features;
wherein generating the ranking of the plurality of features is based on the feature importance score for each feature in the plurality of features.

8. The method of claim 7, wherein generating the feature importance score is performed using a permutation feature importance technique.

9. The method of claim 1, wherein generating the training data set comprises:
receiving remainder data that is based on a demand data set that comprises a particular time series data set that reflects user behavior over time; and
including, in each training instance of the training data set, for the response variable, a value that is from the remainder data.

10. The method of claim 9, wherein the remainder data is time series data that comprises a plurality of values, each of which corresponds to a different time period of a plurality of time periods.

11. One or more storage media storing instructions which, when executed by one or more computing devices, cause:
generating a plurality of sets of artificial feature values, wherein generating the plurality of sets of artificial feature values comprises:
identifying a set of feature values in a plurality of sets of feature values;
shuffling the set of feature values to generate a set of artificial feature values, wherein the set of artificial feature values is included in the plurality of sets of artificial feature values;
for each set of artificial feature values of the plurality of sets of artificial feature values:
generating a training data set based on said each set of artificial feature values and the plurality of sets of feature values;
wherein each set of feature values in the plurality of sets of feature values corresponds to a different feature of a plurality of features;
generating a machine-learned model based on the training dataset;
based on the machine-learned model, generating a ranking of the plurality of features;
adding the machine-learned model to a set of machine-learned models;
storing the ranking in a dictionary, of a plurality of dictionaries, that corresponds to said each set of artificial feature values;
for each feature of the plurality of features:
for each dictionary of the plurality of dictionaries:
generating a rank pair comprising (1) a rank of said each feature, in said each dictionary, relative to other features of the plurality of features and (2) a rank of an artificial feature, in said each dictionary, relative to other features of the plurality of features;
adding the rank pair to a set of rank pairs associated with said each feature;
wherein after generating the rank pair for each dictionary of the plurality of dictionaries, the set of rank pairs is a plurality of rank pairs associated with said each feature;
based on the plurality of rank pairs associated with said each feature, determining whether there is significant correlation between said each feature and a response variable of the set of machine-learned models.

12. The one or more storage media of claim 11, wherein determining whether there is significant correlation comprises:
conducting a statistical test based on the set of rank pairs that results in a p-value for said each feature;
determining whether the p-value is less than a particular threshold.

13. The one or more storage media of claim 11, wherein generating the plurality of sets of artificial feature values comprises generating a particular set of artificial feature values, in the plurality of sets of artificial feature values, based on a particular set of feature values in the plurality of sets of feature values.

14. The one or more storage media of claim 13, wherein generating the particular set of artificial feature values comprises randomly shuffling feature values in the particular set of feature values to generate the particular set of artificial feature values.

15. The one or more storage media of claim 11, wherein generating the plurality of sets of artificial feature values comprises, for each set of feature values in the plurality of sets of feature values, generating multiple sets of artificial feature values.

16. The one or more storage media of claim 11, wherein generating the machine-learned model comprises using a gradient boosting machine to generate a regression model.

17. The one or more storage media of claim 11, wherein the instructions, when executed by the one or more processors, further cause:
based on the machine-learned model, generating a feature importance score for each feature in the plurality of features;
wherein generating the ranking of the plurality of features is based on the feature importance score for each feature in the plurality of features.

18. The one or more storage media of claim 17, wherein generating the feature importance score is performed using a permutation feature importance technique.

19. The one or more storage media of claim 11, wherein generating the training data set comprises:
receiving remainder data that is based on a demand data set; and
including, in each training instance of the training data set, for the response variable, a value that is from the remainder data.

20. The one or more storage media of claim 19, wherein the remainder data is time series data that comprises a plurality of values, each of which corresponds to a different time period of a plurality of time periods.
